(19) United States
(12) Patent Application Publication
(10) Pub. No.: US 2025/0153042 A1
(43) Pub. Date: May 15, 2025

(54) DATA TRANSPORT SYSTEMS, DEVICES AND METHODS

(71) Applicant: SKYWORKS SOLUTIONS, INC., Irvine, CA (US)

(72) Inventors: Thomas Jakob IRRGANG, Portland, OR (US); Alexander Christian STANGE, Portland, OR (US)

(21) Appl. No.: 18/946,338

(22) Filed: Nov. 13, 2024

Related U.S. Application Data
(60) Provisional application No. 63/598,390, filed on Nov. 13, 2023.

(51) Int. Cl. A63F 13/327; A63F 13/24

(52) U.S. Cl. CPC A63F 13/327; A63F 13/24

(57) ABSTRACT

A wireless data transport architecture can include a transmit-side device having one or more sensors and configured to form a map with information about the one or more sensors. The wireless data transport architecture can further include a receive-side device configured to receive wireless data from the transmit-side device and generate a map having information about the one or more sensors of the transmit-side device. The transmit-side device and the receive-side device can be configured such that the wireless data includes a reference frame containing information about the one or more sensors, and one or more differential frames each containing information about a change among the one or more sensors, with the reference frame and the one or more differential frames being transported between the transmit-side and the receive-side device during different times.

### CROSS-REFERENCE TO RELATED APPLICATION(S)

This application claims priority to U.S. Provisional Application No. 63/598,390 filed Nov. 13, 2023, entitled DATA TRANSPORT SYSTEMS, DEVICES AND METHODS, the disclosure of which is hereby expressly incorporated by reference herein in its respective entirety.

### BACKGROUND

### Field

The present disclosure relates to data transport systems, devices and methods.

### Description of the Related Art

In many electronic applications, a wireless device is typically configured to communicate with a base device to provide various functionalities such as control functionality, monitoring functionality and sensing functionality. When in operation, such a wireless device typically transfers data to the base device during a data transport cycle.

In many electronic applications, it is desirable to have a rate of data transfer to be sufficiently high, such that information being provided from the wireless device to the base device is approximately or close to real-time.

### SUMMARY

In accordance with a number of implementations, the present disclosure relates to a wireless data transport architecture that includes a transmit-side device that includes one or more sensors and configured to form a map having information about the one or more sensors. The wireless data transport architecture further includes a receive-side device configured to receive wireless data from the transmit-side device and generate a map having information about the one or more sensors of the transmit-side device. The transmit-side device and the receive-side device are configured such that the wireless data includes a reference frame containing information about the one or more sensors, and one or more differential frames each containing information about a change among the one or more sensors. The reference frame and the one or more differential frames are transported between the transmit-side and the receive-side device during different times.

In some embodiments, the transmit-side device can be a user-interface (UI) device. In some embodiments, the UI device can be a gaming controller device. In some embodiments, the one or more sensors of the UI device can include one or more buttons and one or more position sensing devices.

In some embodiments, the reference frame can include all of the information contained in the map of the transmit-side device, such that the map of the receive-side device also includes all of the information contained in the map of the transmit-side device.

In some embodiments, the map of the receive-side device can be substantially a mirror image of the map of the transmit-side device. In some embodiments, the map of the transmit-side device can include substantially all outputs of the one or more sensors.

In some embodiments, the map of the transmit-side device can include part of outputs of the one or more sensors. In some embodiments, the wireless data transport architecture can further include one or more additional maps on the transmit-side device such that the one or more additional maps on the transmit-side device includes the remaining portions of the outputs of the one or more sensors. In some embodiments, the map on the receive-side device can include information about the part of outputs of the one or more sensors.

In some embodiments, the wireless data transport architecture can further include one or more additional maps on the receive-side device such that the one or more additional maps on the receive-side device includes information about the remaining portions of the outputs of the one or more sensors. In some embodiments, the map and each of the additional maps on the transmit-side device can correspond to first and second reference frames, such that the first and second reference frames are transported at different times.

In some implementations, the present disclosure relates to a method for performing wireless data transport. The method includes forming a map on a transmit-side such that the map includes information about one or more sensors on the transmit-side, and transmitting wireless data from the transmit-side such that the wireless data includes a reference frame containing information about the one or more sensors, and one or more differential frames each containing information about a change among the one or more sensors. The method further includes forming a map on a receive-side based on the wireless data such that the map includes information about the one or more sensors.

According to some implementations, the present disclosure relates to a wireless device that includes one or more sensors configured to sense inputs provided by a user, and a circuit configured to generate a map having information about the one or more sensors. The circuit is further configured to transmit wireless data that includes a reference frame information about the map, and one or more differential frames each containing information about a change in the map, with the reference frame and the one or more differential frames being transmitted at different times.

In some embodiments, the wireless device can be implemented as a user-interface device. In some embodiments, the user-interface device can be implemented as a gaming controller device. In some embodiments, the circuit can be implemented on a system-on-chip (SOC).

According to some implementations, the present disclosure relates to a wireless device that includes a wireless device having a receiver circuit configured to receive wireless data that includes a reference frame and one or more differential frames, with the reference frame and the one or more differential frames being received at different times, and the reference frame containing information about one or more sensors on a transmit device, and each of the one or more differential frames containing information about a change in the one or more sensors. The wireless device further includes a mapping circuit configured to form a map based on the reference frame, and to update the map based on each of the one or more differential frames, such that the map corresponds to a map on the transmit device having information about the one or more sensors.

In some embodiments, the wireless device can be implemented as a base device capable of communicating with a plurality of transmit devices including the transmit device. In some embodiments, the base device can be implemented as a gaming console.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1A depicts a data transport configuration involving a control device having one or more sensors.

FIG. 1B shows a data transport configuration involving two control devices with each being similar to the control device of FIG. 1A.

FIG. 2 shows a data transport configuration having one or more features of the present disclosure.

FIG. 3 shows a process that can be implemented on a transmit side for a data transport configuration similar to the data transport configuration of FIG. 2.

FIG. 4 shows a process that can be implemented on a receive side for a data transport configuration similar to the data transport configuration of FIG. 2.

FIG. 5 shows a data transport configuration that can be a more specific example of the data transport configuration of FIG. 2.

FIG. 6 shows a data transport configuration that can be a more specific example of the data transport configuration of FIG. 5.

FIG. 7 shows a data transport configuration involving two user interface (UI) devices with each being similar to the control device of FIG. 6.

FIG. 8 shows a data transport configuration that includes a UI device having a plurality of sensors.

FIG. 9 shows an example of a data transport configuration for wireless gaming control application corresponding to the example of FIG. 1B.

FIG. 10 shows an example of a data transport configuration for wireless gaming control application corresponding to the example of FIG. 7.

FIG. 11 shows an example of a data transport configuration for wireless gaming control application corresponding to the example of FIG. 8.

### DETAILED DESCRIPTION OF SOME EMBODIMENTS

The headings provided herein, if any, are for convenience only and do not necessarily affect the scope or meaning of the claimed invention.

In many electronic applications, one or more wireless devices are configured to communicate with a base device to provide various functionalities such as control functionality, monitoring functionality and sensing functionality. For the purpose of description, a wireless device having some or all of such functionalities can be referred to as a control device.

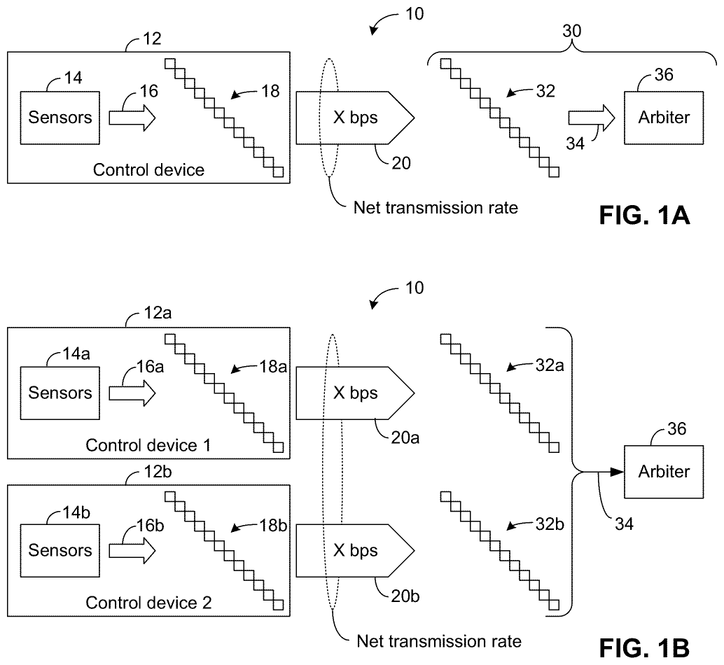

For example, FIG. 1A depicts a data transport configuration 10 involving a control device 12 having one or more sensors collectively indicated as 14. When in operation, the control device 12 can be configured to scan such sensor(s) and generate (16) scanned data 18 to be sent wirelessly (20) during a data transport cycle to a receiving side 30 associated with a base device. On the receiving side 30, received data 32 can have a generally similar structure as the scanned data, and such received data can be mapped (34) onto an arbiter 36 associated with the host device. It will be understood that the arbiter 36 can be implemented as a plug-in part associated with the host device, a permanent part of the host device, or some combination thereof.

Configured in the foregoing manner, it is desirable to have a rate of the wireless data transmission 20 to be sufficiently high, such that the information (associated with the sensors 14 of the control device 12) being provided to the host device is approximately or close to real-time. For example, in many user-interface (UI) applications such as gaming applications, a standard mode can allow updating information from a wireless control device to a host device once every 4 ms (250 transactions per second); a fast mode can update once every 2 ms (500 transactions per second); and an ultra-fast mode can update once every 1 ms (1,000 transactions per second). In the context of such example update rates, and assuming that X bits of data is needed for each transaction, Table 1 provides a summary of corresponding data transport rates. Table 2 provides a summary of data transport rates if the value of X is, for example, 512 bits (64 bytes).

TABLE 1

| | Transaction | Transaction rate | |
|---|---|---|---|
| Mode | duration (ms) | (per second) | Data rate (bps) |
| Standard | 4 | 250 | 250X |
| Fast | 2 | 500 | 500X |
| Ultra-fast | 1 | 1,000 | 1,000X |

TABLE 2

| | Transaction | Transaction rate | |
|---|---|---|---|
| Mode | duration (ms) | (per second) | Data rate (kbps) |
| Standard | 4 | 250 | 128 |
| Fast | 2 | 500 | 256 |
| Ultra-fast | 1 | 1,000 | 512 |

In the example of FIG. 1A, a net transmission rate associated with the receiving side 30 is essentially the data transmission rate discussed above in reference to FIG. 1 and Tables 1 and 2, since there is only one control device 12. FIG. 1B shows a data transport configuration 10 involving two control devices 12a, 12b with each being similar to the control device 12 of FIG. 1A. Accordingly, wireless data transmission rate (20a, 20b) associated with each control device (12a, 12b) is indicated as X bps.

In the example of FIG. 1B, received data 32a, 32b from the respective control devices 12a, 12b are shown to be mapped (34) onto an arbiter 36 associated with the host device. Accordingly, net data transmission rates associated with the example operating modes (standard, fast, ultra-fast) are essentially twice the values of Tables 1 and 2 associated with a single-control device configuration.

Extending the example of FIG. 1B to a more general configuration involving N control devices where N>1, net data transmission rates associated with the example operating modes (standard, fast, ultra-fast) are essentially N times the values of Tables 1 and 2 associated with a single-control device configuration.

From the foregoing examples, one can see that net transmission rate increases essentially linearly with respect to the number of control devices. In some applications, such a linear increase in net transmission rate can limit the number of control devices for a given host device, and/or lead to increased lag time associated with control responses.

It is also noted that in the foregoing examples where net transmission rate increases essentially linearly with respect to the number of control devices, data transport can be inefficient, especially in situations where transmitted data includes significant amount of redundant information.

Disclosed herein are examples of systems, devices and methods related to techniques where the amount of required or desired net transmission rate can be reduced. Such a net transmission rate may be referred to herein as OTA (over-the-air) payload (e.g., transmitted data, bandwidth, etc.). While some of such examples are described in the context of wireless devices with UI (User Interface) elements, it will be understood that one or more features of the present disclosure can also be implemented in other settings.

In some embodiments, one or more features of the present disclosure can result in a significant reduction in the amount of required or desired OTA-payload for wireless devices with data transmission where the transmitted data has redundancy due to the same (unchanged) data being transmitted repeatedly. As an example of such redundancy, suppose that a button is coupled wirelessly to a doorbell, and the button gets scanned once per second. Most of the time, the button is off (e.g., “0”); and if the button gets pressed (changing to “1”), the doorbell will ring no later than 1 second later due to the once-per-second scan.

It is noted that in the foregoing doorbell example, the corresponding system will transmit “0”s most of the time; and only transmit a “1” when the button is pressed occasionally. Thus, in such a system, there is no reduction in the required payload, since the transmitted data as is at a rate that is not optimized to reduce required OTA-payload.

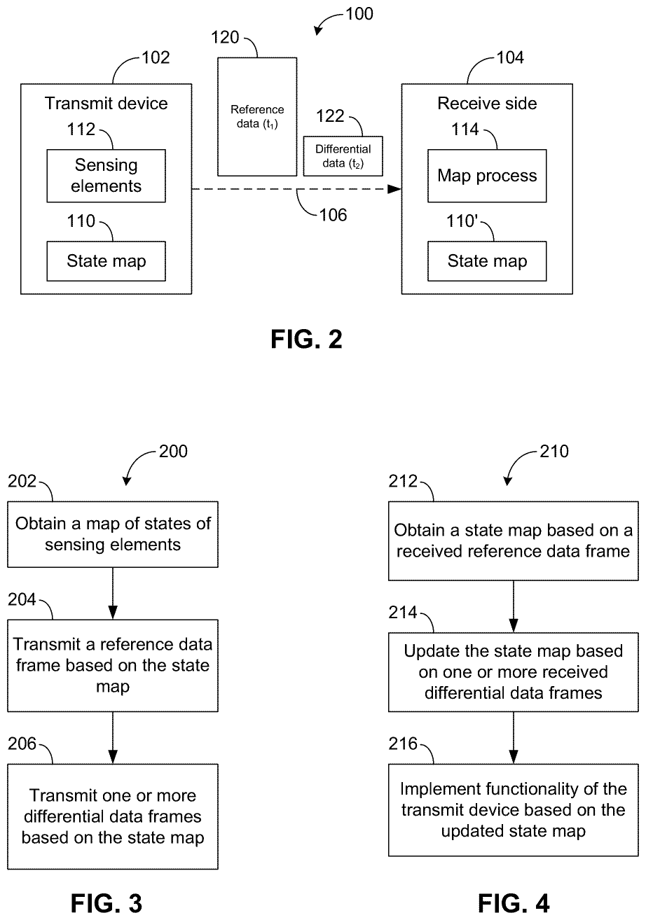

FIG. 2 shows a data transport configuration 100 having one or more features of the present disclosure. In some embodiments, such a data transport configuration can include a transmit-side device 102 having a plurality of sensing elements collectively indicated as 112. As described herein, a state map 110 that includes states of such sensing elements can be provided for the transmit device 102.

In FIG. 2, data transmitted (106) from the transmit device 102 to a receive side 104 associated with a base device can include a reference data block 120 and one or more differential data blocks 122. In some embodiments, such data blocks can be transmitted at different respective transactions. Accordingly, in the example of FIG. 2, the reference data block 120 transmitted at time t1 is in a respective transaction that is different from a transaction associated with the differential data block 122 transmitted at time t2. Examples related to the reference data block 120 and the differential data block 122 are described herein in greater detail.

FIG. 2 shows that in some embodiments, the receive side 104 can include a map process block 114 that receives the data 106 and generates a state map 110′. In some embodiments, such a state map (110′) can include substantially the same information as the respective state map (110) on the transmit side 102 after a given transaction. In some embodiments, the state map (110′) can be a mirror image of the respective state map (110) on the transmit side 102 after a given transaction.

Configured in the foregoing manner, the state map 110′ on the receive side 104 can be utilized by the respective base device to implement states of the sensing elements 112 of the transmit device 102 on a transaction-to-transaction basis. As described herein, use of the reference data block 120 and the differential data block(s) 122 can allow the amount of transmitted data to be reduced in a desirable manner.

FIG. 3 shows a process 200 that can be implemented on a transmit side for a data transport configuration similar to the data transport configuration 100 of FIG. 2. In a process block 202, a map can be obtained to include states of sensing elements. In a process block 204, a reference data frame based on the state map can be transmitted during a respective transaction. In a process block 206, one or more differential data frames based on the state map can be transmitted in respective transaction(s).

FIG. 4 shows a process 210 that can be implemented on a receive side for a data transport configuration similar to the data transport configuration 100 of FIG. 2. In a process block 212, a state map can be obtained based on a received reference data frame. In a process block 214, the state map can be updated based on one or more received differential data frames. In a process block 215, functionality of the transmit device can be implemented based on the updated state map.

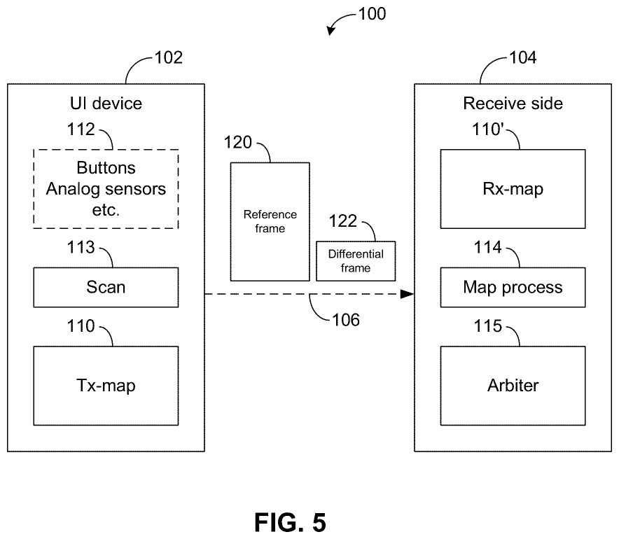

FIG. 5 shows a data transport configuration 100 that can be a more specific example of the data transport configuration 100 of FIG. 2. FIG. 5 shows that in some embodiments, the transmit-side device 102 of FIG. 2 can be implemented as a user interface (UI) device 102 configured to sense a user's control input to be implemented by a base device coupled wirelessly with the UI device 102.

FIG. 5 shows that in some embodiments, the sensing elements 112 of FIG. 2 can include, for example, buttons, analog sensors, etc. collectively indicated as 112. By way of examples, a button can provide an ON/OFF functionality when engaged, and an analog sensor can include an electrical and/or magnetic sensor having an output. It will be understood that the output of the analog sensor may or may not be converted into a digital format for obtaining of a map (110 in FIG. 5). Some non-limiting examples of analog sensors can include a potentiometer, a capacitive sensor, and inductive sensor, a position sensor such as a rotary encoder, etc.

Referring to FIG. 5, the UI device 102 can include a scan block 113 and a transmit map (Tx-map) 110. In some embodiments, the scan block 113 can scan states of the various sensors 112 by, for example, scanning outputs of the sensors 112 during a sampling period (e.g., 1 ms to provide a scan rate of 1,000 per second). In some embodiments, the Tx-map 110 include digital information associated with the states of the sensors provided by the scan block 113.

Referring to FIG. 5, data transmitted (106) from the UI device 102 to a receive side 104 can include a reference data frame 120 and one or more differential data frames 122. In some embodiments, such data frame(s) can be transmitted at different transactions. Examples related to the reference data frame 120 and the differential data frame(s) 122 are described herein in greater detail.

Referring to FIG. 5, the receive side 104 can be configured to receives the data 106 and generate a state map (Rx-map) 110′. In some embodiments, such an Rx-map (110′) can include substantially the same information as the Tx-map (110) on the UI device 102 after a given transaction. In some embodiments, the Rx-map (110′) can be a mirror image of the Tx-map (110) on the UI device 102 after a given transaction.

Referring to FIG. 5, the receive side 104 can include a map process block 114 configured to map one or more Rx-maps onto an arbiter 115 associated with a respective base device. Configured in the foregoing manner, the Rx-map 110′ on the receive side 104 can be utilized by the respective base device to implement states of the sensors 112 of the UI device 102 on a transaction-to-transaction basis. As described herein, use of the reference data block 120 and the differential data block(s) 122 can allow the amount of transmitted data to be reduced in a desirable manner.

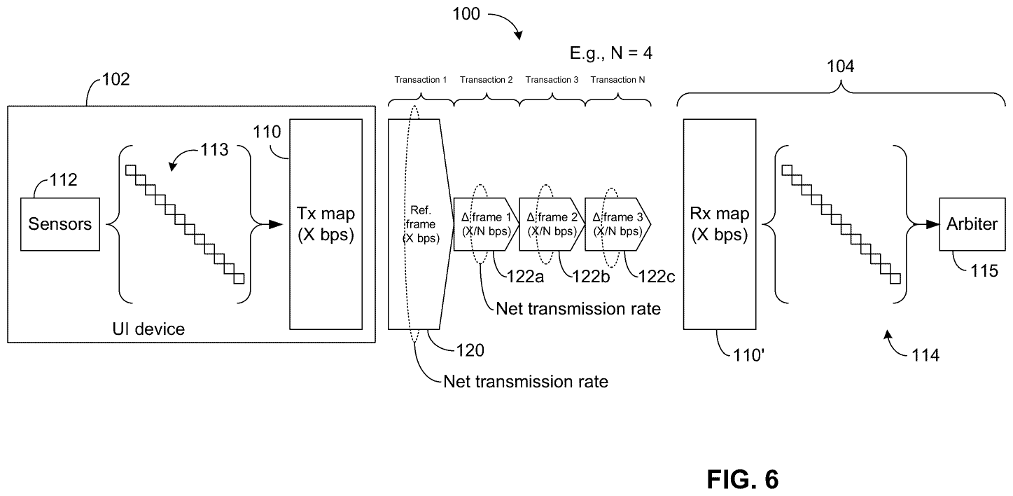

FIG. 6 shows a data transport configuration 100 that can be a more specific example of the data transport configuration 100 of FIG. 5. In FIG. 6, the data transport configuration 100 is shown to involve a UI device 102 having one or more sensors collectively indicated as 112. When in operation, the UI device 102 can be configured to scan such sensor(s) and generate scanned data 113. The UI device 102 can be further configured to generate a Tx-map 110 from the scanned data 113. Such a Tx-map is shown to have a size to involve X bps per transaction transmission rate.

In the example of FIG. 6, the data transport configuration 100 is shown to involve a receiving side 104 associated with a base device. On the receiving side 104, an Rx-map 110′ is shown to be updated with data received from the UI device 102, such that the Rx-map 110′ can have substantially the same information as in the Tx-map 110 of the UI device 102. In some embodiments, the Rx-map 110′ can be a mirror image of the Tx-map 110 of the UI device 102, such that a map process block 114 that maps the Rx-map 110′ onto an arbiter 115 provides a functionality similar to the receive-as-scanned data (32 in FIG. 1A) being generated from the send-as-scanned data (18 in FIG. 1A) described herein in reference to FIG. 1A.

In the example of FIG. 6, data being transmitted from the UI device 102 is shown to include N transactions, where N=4 as an example. In the four transactions, one transaction (e.g., the first transaction) is shown to involve transmission of a reference frame 120 obtained from the Tx-map 110, and each of the three remaining transactions is shown to involve transmission of a differential frame (also referred to herein as a Δ frame or delta frame) (122a, 122b, 122c). Such a set of four transactions can repeat in a similar manner.

In some embodiments, the reference frame 120 can include all of the information in the Tx-map 110; and thus can involve X bps per transaction transmission rate. In some embodiments, such a reference frame can be utilized to replace an existing Rx-map (110′) or form an initial Rx-map during an initialization process (e.g., at power-up).

In some embodiments, each of the three Δ frames 122a, 122b, 122c can involve a reduced transmission rate at, for example, X/N bps per transaction. Thus, in the N=4 example, each Δ frame can involve a reduced transmission rate of X/4 bps per transaction. In some embodiments, each Δ frame can be utilized to update the current Rx-map (110′).

In the example of FIG. 6, N=4, such that a reference frame (120) is sent on every fourth transaction, and in each of the other three transactions in a set of given four-transactions, a differential frame is sent. In some embodiments, each differential frame contains data that changed relative to the latest Tx-map (110). In the example of N=4, size of such data in the differential frame is up to 25% of the size of the reference frame.

In some embodiments, the number of transactions in a given set can be selected based on an operational assumption where no more than x % will ever change in any set of N transactions. Thus, the foregoing N=4 example where the differential frame is up to 25% of the reference frame can be based on such an operational assumption.

It is noted that if a lower percentage change (e.g., less than 25%) is expected over N transactions, N can be made greater than the foregoing value of 4. For example, if no more than 10% is expected to change over N transactions, N can be, for example, 10. It will be understood that the value of N may or may not be the inverse of fractional value of x %.

In the example of FIG. 6, each transaction is shown to have a net transmission rate, such that each set of N transactions has a peak rate, a low rate, and an average rate. In the N=4 example, each set of 4 transactions is shown to have a peak rate of X bps (corresponding to the reference frame 120), a low rate of X/4 bps (corresponding to any of the three differential frames 122a, 122b, 122c), and an average rate of (7/16)X. It is noted that if X=512 kbps, the peak rate has a value of 512 kbps, the low rate has a value of 128 kbps, and the average rate has a value of 224 kbps.

Based on the foregoing example of FIG. 6, one can see that the data transport configuration 100 of FIG. 6 has a peak rate that is the same as the single transmission rate in the example of FIG. 1A (e.g., 512 kbps for an ultra-fast mode), but an average rate that is less than half (7/16) of the peak rate for 3/4 of transmission time. It is noted that such a reduced transmission rate is provided while still providing a functionality where scanned data in a UI device is mapped onto an arbiter as if it received date serially by a direct sensor scan.

It is noted that in the example of FIG. 6, even though the average rate is significantly lower, the peak rate (e.g., 512 kbps for an ultra-fast mode) is still the same as the single transmission rate in the example of FIG. 1A. However, it is further noted that an overall peak rate of transmission desirably decreases when a plurality of UI devices interact with a given base device.

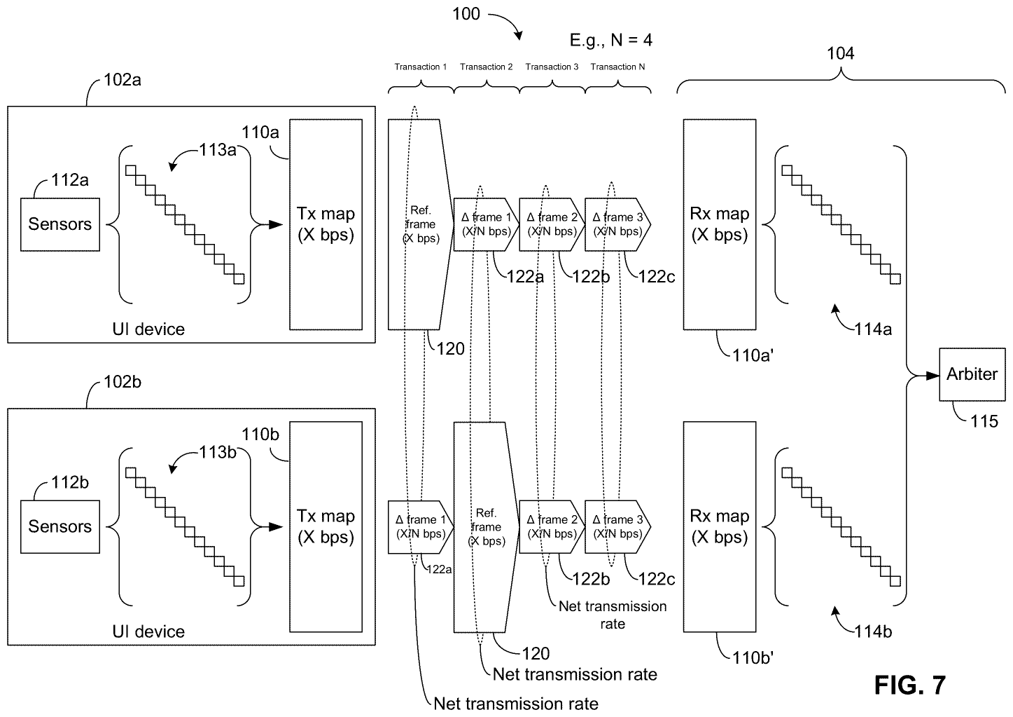

For example, FIG. 7 shows a data transport configuration 100 involving two UI devices 102a, 102b with each being similar to the control device 102 of FIG. 6. In the example of FIG. 7, the data transport configuration 100 is shown to involve a receiving side 104 associated with a base device. On the receiving side 104, an Rx-map (110a′, 110b′) is shown to be provided and updated with data received from the respective UI device (102a, 102b), such that each Rx-map can have substantially the same information as in the Tx-map of the corresponding UI device. In some embodiments, each Rx-map can be a mirror image of the Tx-map of the corresponding UI device, such that map process blocks 114a, 114b that maps the Rx-maps 110a′, 110b′ onto an arbiter 115 provides a functionality similar to the receive-as-scanned data (32a, 32b in FIG. 1B) being generated from the send-as-scanned data (18a, 18b in FIG. 1B) described herein in reference to FIG. 1B.

In the example of FIG. 7, each UI device is shown to transmit with an N=4 configuration similar to FIG. 6. In some embodiments, among such four transactions in the N=4 set, the reference frames 120 can be transmitted at different transactions. For example, the first UI device 102a is shown to have its reference frame 120 transmitted in the first transaction, and the remaining transactions (second, third, fourth) are shown to be utilized to transmit differential frames 122a, 122b, 122c. The second UI device 102b is shown to have its reference frame 120 transmitted in the second transaction, and the remaining transactions (first, third, fourth) are shown to be utilized to transmit differential frames 122a, 122b, 122c.

It is noted that the foregoing example can be extended to a data transport configuration 100 having N UI devices. More particularly, if there are three UI devices, the third UI device can have its reference frame transmitted in the third transaction, and the remaining transactions (first, second, fourth) can be utilized to transmit differential frames. Similarly, if there are four UI devices, the fourth UI device can have its reference frame transmitted in the fourth transaction, and the remaining transactions (first, second, third) can be utilized to transmit differential frames.

It is noted that if there are more than N UI devices (e.g., more than four UI devices), the value of N can be increased to accommodate the foregoing configuration where only one reference frame is transmitted in a given transaction among N devices.

It is also noted that even if there are more than N UI devices (e.g., more than four UI devices), the value of N can remain the same (e.g., N=4) by configuring data transport such that in any given transaction, the number of reference frame(s) being transmitted is less than N. In such an example configuration, suppose there are five UI devices and N=4. Then, for example, the first transaction can be utilized to transmit reference frames for the first and fifth UI devices, and the second, third and fourth transactions can be utilized to transmit reference frames for the second, third and fourth UI devices, respectively.

It is noted that in the example of FIG. 1B, net data transmission rates associated with the example operating modes (standard, fast, ultra-fast) for N control devices are essentially N times the values associated with a single-control device configuration. In the examples of FIGS. 6 and 7, however, N UI devices does not result in a linear increase in peak rates. Table 3 lists various net transmission rates for different numbers of UI devices, in the example context of N=4 and an ultra-fast mode where an update is made once every 1 ms (1,000 transactions per second). Table 4 shows a comparison of the differential data transport configurations of FIGS. 6 and 7 and the no-differential data transport configuration of FIG. 1B, again in the example context of N=4 and ultra-fast mode.

TABLE 3

| No. of UI | | | Average |
|---|---|---|---|
| devices | Peak rate (kbps) | Low rate (kbps) | rate (kbps) |
| 1 | 512 | 128 | 224 |
| 2 | 512 + 128 = 640 | 128 + 128 = 256 | 448 |
| 3 | 512 + 128 + | 128 + 128 + | 672 |
| | 128 = 768 | 128 = 384 | |
| 4 | 512 + 128 + 128 + | 128 + 128 + 128 + | 512 |
| | 128 = 896 | 512 = 896 | |

TABLE 4

| | Differential data | Differential data | No-differential |
|---|---|---|---|
| No. of UI | transport peak | transport average | data transport |
| devices | rate (kbps) | rate (kbps) | rate (kbps) |
| 1 | 512 | 224 | 512 |
| 2 | 640 | 448 | 2 × 512 = 1,024 |
| 3 | 768 | 672 | 3 × 512 = 1,536 |
| 4 | 896 | 512 | 4 × 512 = 2,048 |

Referring to Tables 3 and 4, one can see that for the single-UI device configuration of FIG. 6, the peak data rate (e.g., 512 kbps) is the same as the data rate of the single-device configuration of FIG. 1A; thus, there is no rate reduction benefit for the peak data rate. However, for the same single-UI device configuration of FIG. 6, the average data rate (e.g., 224 kbps) is less than half of the data rate (512 kbps) of the single-device configuration of FIG. 1A; thus, rate reduction benefit such as lower transmit power consumption of the single UI device can be realized.

Referring to Tables 3 and 4, one can see that as more devices are added, even the data rate of the differential data transport configuration of FIG. 7 benefits from rate reduction when compared to the no-differential data transport configuration of FIG. 1B. More specifically, when two devices are in use, the ratio of peak rate of FIG. 7 and the rate of FIG. 1B is 640/1024=0.63; when three devices are in use, the ratio of peak rate of FIG. 7 and the rate of FIG. 1B is 768/1536=0.50; and when four devices are in use, the ratio of peak rate of FIG. 7 and the rate of FIG. 1B is 896/2048=0.44.

It is also noted that when two devices are in use, the ratio of average rate of FIG. 7 and the rate of FIG. 1B is 448/1024=0.44; when three devices are in use, the ratio of average rate of FIG. 7 and the rate of FIG. 1B is 672/1536=0.44; and when four devices are in use, the ratio of average rate of FIG. 7 and the rate of FIG. 1B is 512/2048=0.25.

Based on the foregoing examples, significant rate reductions can be realized with four devices in use. More particularly, the ratio of peak rate of FIG. 7 and the rate of FIG. 1B is 0.44 which corresponds to a 56% reduction. Similarly, the ratio of average rate of FIG. 7 and the rate of FIG. 1B is 0.25 which corresponds to a 75% reduction.

It is noted that in the examples of FIGS. 6 and 7, a reference frame is sized to contain information to allow replicate a Tx-map on the receive side as an Rx-map. With such a configuration, reduction in data rate between the Tx side and the Rx side can be reduced, especially when the number of Tx devices increases; and such a rate reduction can be achieved by sending full reference frames are different transaction times.

In some embodiments, a reference frame itself can be configured to contain partial information of a full Tx-map, and a plurality of such reference frames can be sent to the receive side at different transaction times. As described herein, such a configuration can result in data rate reduction, even for a single-device data transport configuration.

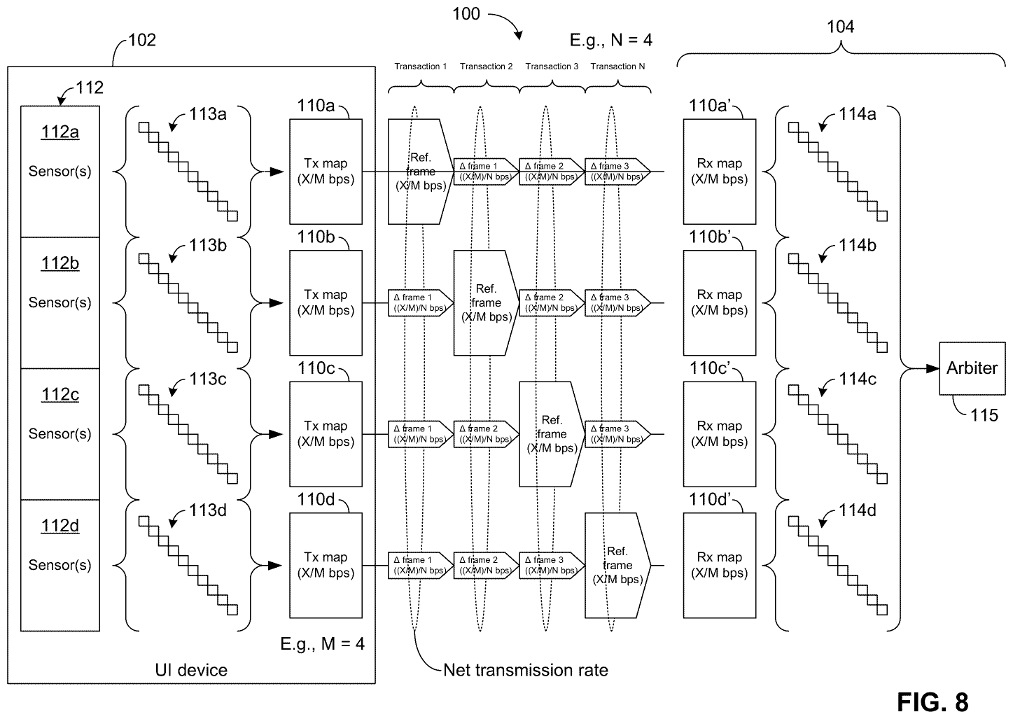

FIG. 8 shows a data transport configuration 100 that includes a UI device 102 having a plurality of sensors collectively indicated as 112. Such sensors are shown to be grouped into M groups (e.g., M=4), such that when in operation, the UI device 102 can be configured to scan each group of sensor(s) and generate a respective scanned data. In FIG. 8, the first group 112a is shown to result in a first scanned data 113a; the second group 112b is shown to result in a second scanned data 113b; the third group 112c is shown to result in a third scanned data 113c; and the fourth group 112d is shown to result in a fourth scanned data 113d.

The UI device 102 can be further configured to generate a partial Tx-map from the respective scanned data. In FIG. 8, a first partial Tx-map 110a (having a size to involve X/M bps per transaction) is shown to be generated from the first scanned data 113a; a second partial Tx-map 110b (having a size to involve X/M bps per transaction) is shown to be generated from the second scanned data 113b; a third partial Tx-map 110c (having a size to involve X/M bps per transaction) is shown to be generated from the third scanned data 113c; and a fourth partial Tx-map 110d (having a size to involve X/M bps per transaction) is shown to be generated from the fourth scanned data 113d. It is noted that in the foregoing example, sizes of the four partial Tx-maps are the same (X/M); however, it will be understood that such sizes may or may not be the same.

In the example of FIG. 8, the data transport configuration 100 is shown to involve a receiving side 104 associated with a base device. On the receiving side 104, a partial Rx-map is shown to be updated with data received from the UI device 102, such that the partial Rx-map can have substantially the same information as in the corresponding partial Tx-map of the UI device 102. More particularly, a first partial Rx-map 110a′ is shown to be updated with data in the first partial Tx-map 110a; a second partial Rx-map 110b′ is shown to be updated with data in the second partial Tx-map 110b; a third partial Rx-map 110c′ is shown to be updated with data in the third partial Tx-map 110c; and a fourth partial Rx-map 110d′ is shown to be updated with data in the fourth partial Tx-map 110d.

In some embodiments, each partial Rx-map can be a mirror image of the corresponding partial Tx-map of the UI device 102, such that map process blocks 114a, 114b, 114c, 114d that map the partial Rx-maps 110a′, 110b′, 110c′, 110d′ onto an arbiter 115 provides a functionality similar to the receive-as-scanned data (32 in FIG. 1A) being generated from the send-as-scanned data (18 in FIG. 1A) described herein in reference to FIG. 1A.

In the example of FIG. 8, data being transmitted from the UI device 102 is shown to include N transactions, where N=4 as an example, similar to the example of FIG. 6. In the four transactions associated with the first group 112a of sensors, one transaction (e.g., the first transaction) is shown to involve transmission of a reference frame obtained from the first partial Tx-map 110a, and each of the three remaining transactions is shown to involve transmission of a differential frame (also referred to herein as a Δ frame or delta frame). Such a set of four transactions can repeat in a similar manner for the first group. Similarly, in the four transactions associated with the second group 112b of sensors, the second transaction is shown to involve transmission of a reference frame obtained from the second partial Tx-map 110b, and each of the three remaining transactions is shown to involve transmission of a differential frame; and such a set of four transactions can repeat in a similar manner for the first group. Similarly, in the four transactions associated with the third group 112c of sensors, the third transaction is shown to involve transmission of a reference frame obtained from the third partial Tx-map 110c, and each of the three remaining transactions is shown to involve transmission of a differential frame; and such a set of four transactions can repeat in a similar manner for the first group. Similarly, in the four transactions associated with the fourth group 112d of sensors, the third transaction is shown to involve transmission of a reference frame obtained from the fourth partial Tx-map 110d, and each of the three remaining transactions is shown to involve transmission of a differential frame; and such a set of four transactions can repeat in a similar manner for the first group.

In some embodiments, each reference frame can include all of the information in the corresponding partial Tx-map; and thus can involve X/M bps per transaction transmission rate. In some embodiments, such a reference frame can be utilized to replace an existing partial Rx-map or form an initial partial Rx-map during an initialization process (e.g., at power-up).

It is noted that in some embodiments, a plurality of UI devices can be implemented, with each having a data transport configuration 100 of FIG. 8.

With the foregoing configurations, and referring to the examples of FIGS. 6 and 7, Table 5 lists various net transmission rates for different numbers of UI devices, in the example context of N=4 and an ultra-fast mode where an update is made once every 1 ms (1,000 transactions per second). Table 6 shows a comparison of the differential data transport configurations of FIG. 8 and the no-differential data transport configuration of FIG. 1B, again in the example context of N=4 and ultra-fast mode.

TABLE 5

| No. of UI | Peak rate | Low rate | Average rate |
|---|---|---|---|
| devices | (kbps) | (kbps) | (kbps) |
| 1 | 224 | 224 | 224 |
| 2 | 448 | 448 | 448 |
| 3 | 672 | 672 | 672 |
| 4 | 896 | 896 | 896 |

TABLE 6

| | Differential data | Differential data | No-differential |
|---|---|---|---|
| No. of UI | transport peak | transport average | data transport |
| devices | rate (kbps) | rate (kbps) | rate (kbps) |
| 1 | 224 | 224 | 512 |
| 2 | 448 | 448 | 1,024 |
| 3 | 672 | 672 | 1,536 |
| 4 | 896 | 896 | 2,048 |

Referring to FIG. 8 and Tables 5 and 6, one can see that significant rate reductions can be realized even with one device in use. More particularly, the ratio of peak rate of FIG. 8 and the rate of FIG. 1B is 0.44 which corresponds to a 56% reduction. Similarly, the ratio of average rate of FIG. 8 (with one device) and the rate of FIG. 1B is also 0.44.

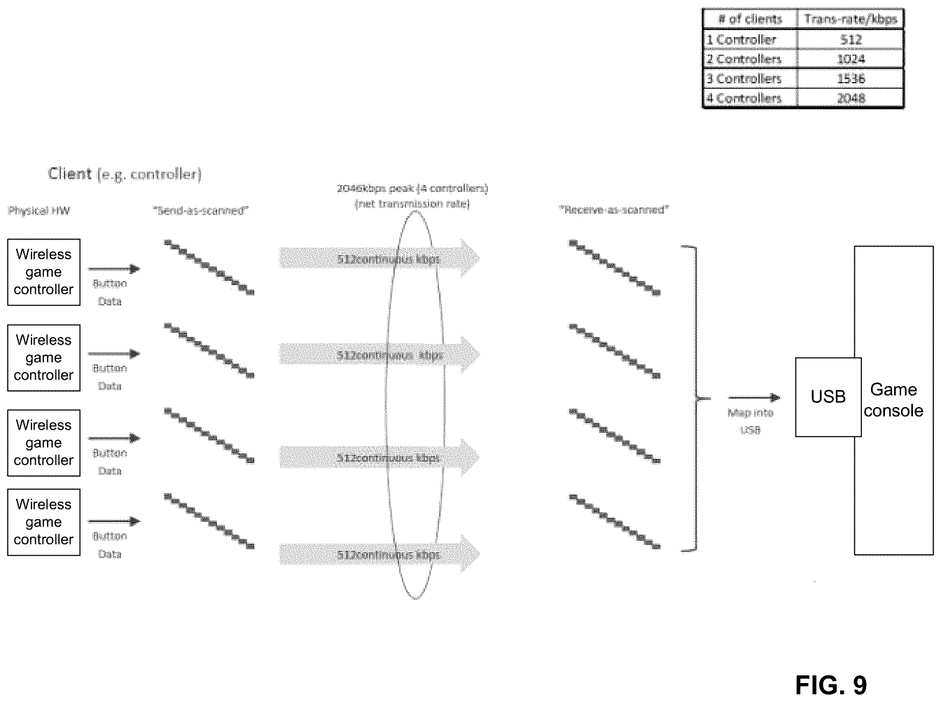

In some embodiments, the UI devices 102 of FIGS. 7 and 8 can be, for example, a wireless gaming controller that includes one or more buttons and one or more joysticks. Examples of implementations data transport configurations for such wireless gaming control applications corresponding to the examples of FIGS. 7 and 8, as well as conventional data transport configuration for wireless gaming control application corresponding to the example of FIG. 1B, are provided in FIGS. 9 to 11.

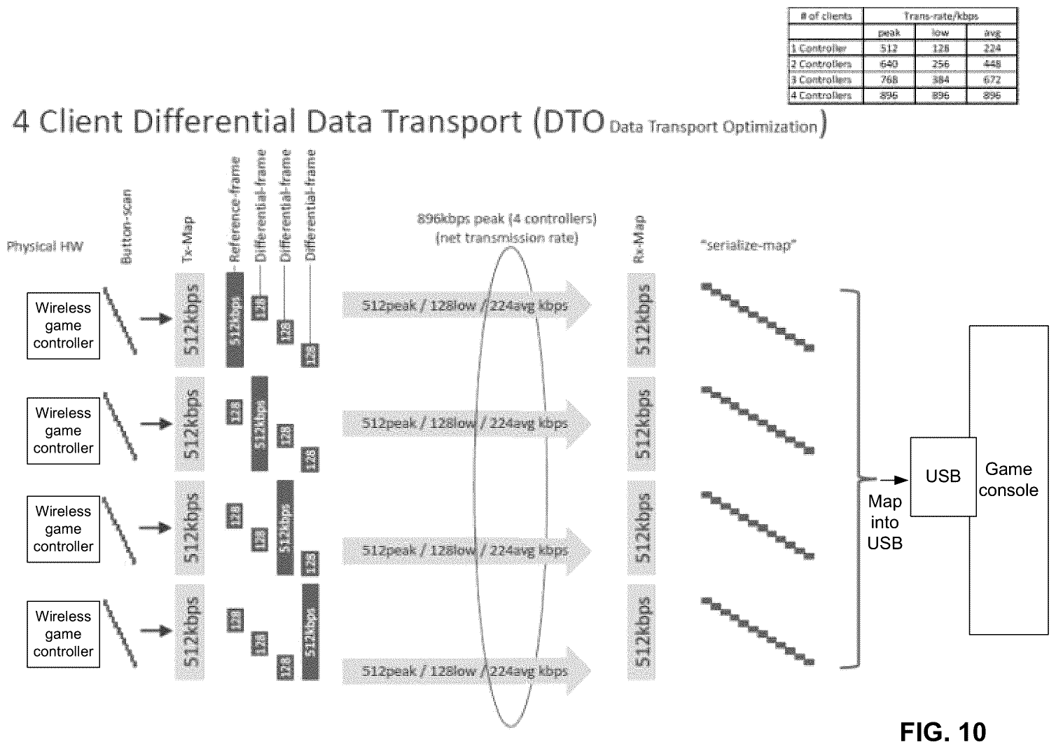

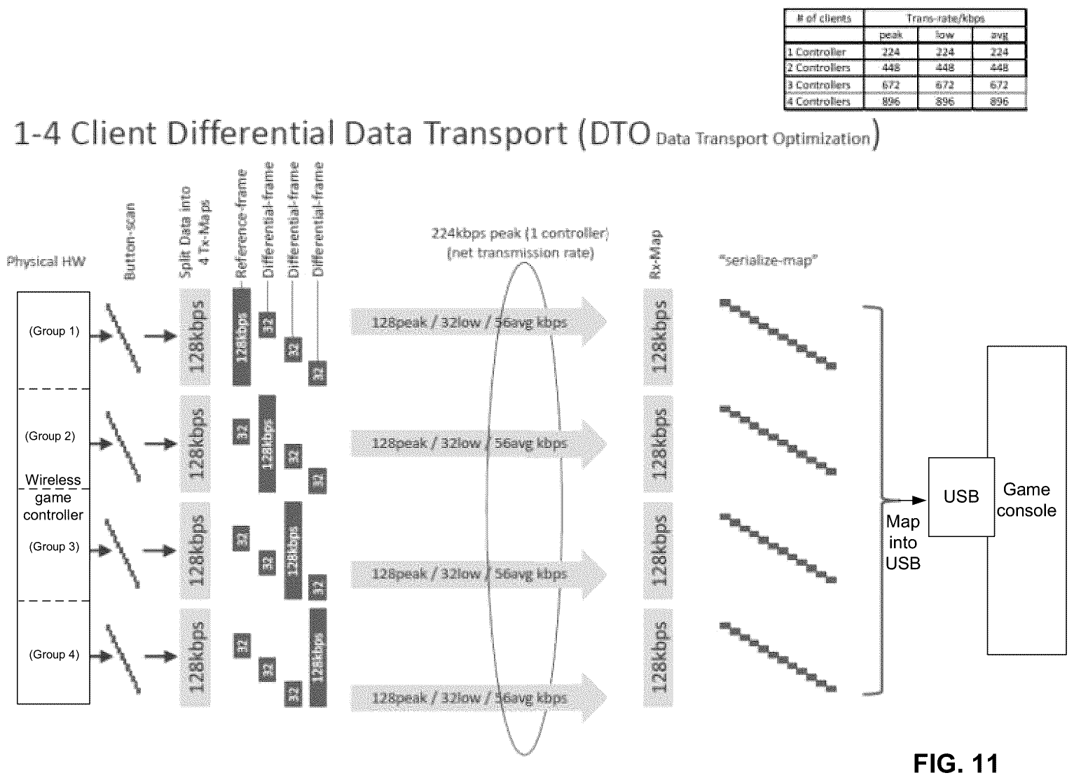

More particularly, FIG. 9 shows an example of a conventional data transport configuration for wireless gaming control application corresponding to the example of FIG. 1B; FIG. 10 shows an example of a data transport configuration for wireless gaming control application corresponding to the example of FIG. 7; and FIG. 11 shows an example of a data transport configuration for wireless gaming control application corresponding to the example of FIG. 8.

In some embodiments, operation of various sensors as well as generation of Tx-map(s) can be provided by, for example, a system-on-chip (SOC) implemented within the gaming controller. In some embodiments, some or all of arbiter functionality can be provided by, for example, a USB device plugged into a game console, permanent part of a game console, or some combination thereof.

As described herein, use of reference data frames and differential data frames with corresponding maps can be particularly advantageous in applications where a number of sensors are implemented with only a limited amount of changes occurring over a time period. It is noted that while some of the examples are described in the context of gaming applications, one or more features of the present disclosure can also be implemented in non-gaming applications including other non-gaming user-interface applications.

For example, data transport with any wireless peripheral device (e.g., wireless keyboard or a wireless mouse) for a computing device can also benefit with implementation of one or more features as described herein.

In another example, any wireless control device where little or no lag in control response time is desirable can also benefit with implementation of one or more features as described herein.

In yet another example, any wireless data transport application where an increased number of wireless transmitting devices communicating with a common receiving device results in a significant increase in bandwidth requirement can also benefit with implementation of one or more features as described herein.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A wireless data transport architecture comprising:
a transmit-side device that includes one or more sensors and configured to form a map having information about the one or more sensors; and
a receive-side device configured to receive wireless data from the transmit-side device and generate a map having information about the one or more sensors of the transmit-side device, the transmit-side device and the receive-side device configured such that the wireless data includes a reference frame containing information about the one or more sensors, and one or more differential frames each containing information about a change among the one or more sensors, the reference frame and the one or more differential frames being transported between the transmit-side and the receive-side device during different times.

2. The wireless data transport architecture of claim 1 wherein the transmit-side device is a user-interface (UI) device.

3. The wireless data transport architecture of claim 2 wherein the user-interface device is a gaming controller device.

4. The wireless data transport architecture of claim 2 wherein the one or more sensors of the user-interface device include one or more buttons and one or more position sensing devices.

5. The wireless data transport architecture of claim 1 wherein the reference frame includes all of the information contained in the map of the transmit-side device, such that the map of the receive-side device also includes all of the information contained in the map of the transmit-side device.

6. The wireless data transport architecture of claim 5 wherein the map of the receive-side device is substantially a mirror image of the map of the transmit-side device.

7. The wireless data transport architecture of claim 5 wherein the map of the transmit-side device includes substantially all outputs of the one or more sensors.

8. The wireless data transport architecture of claim 5 wherein the map of the transmit-side device includes part of outputs of the one or more sensors.

9. The wireless data transport architecture of claim 6 further comprising one or more additional maps on the transmit-side device such that the one or more additional maps on the transmit-side device includes the remaining portions of the outputs of the one or more sensors.

10. The wireless data transport architecture of claim 9 wherein the map on the receive-side device includes information about the part of outputs of the one or more sensors.

11. The wireless data transport architecture of claim 10 further comprising one or more additional maps on the receive-side device such that the one or more additional maps on the receive-side device includes information about the remaining portions of the outputs of the one or more sensors.

12. The wireless data transport architecture of claim 11 wherein the map and each of the additional maps on the transmit-side device correspond to first and second reference frames, such that the first and second reference frames are transported at different times.

13. (canceled)

14. A wireless device comprising:
one or more sensors configured to sense inputs provided by a user; and
a circuit configured to generate a map having information about the one or more sensors, the circuit further configured to transmit wireless data that includes a reference frame information about the map, and one or more differential frames each containing information about a change in the map, the reference frame and the one or more differential frames being transmitted at different times.

15. The wireless device of claim 14 wherein the wireless device is implemented as a user-interface device.

16. The wireless device of claim 15 wherein the user-interface device is implemented as a gaming controller device.

17. The wireless device of claim 16 wherein the circuit is implemented on a system-on-chip (SOC).

18. A wireless device comprising:
a receiver circuit configured to receive wireless data that includes a reference frame and one or more differential frames, the reference frame and the one or more differential frames being received at different times, the reference frame containing information about one or more sensors on a transmit device, and each of the one or more differential frames containing information about a change in the one or more sensors; and
a mapping circuit configured to form a map based on the reference frame, and to update the map based on each of the one or more differential frames, the map corresponding to a map on the transmit device having information about the one or more sensors.

19. The wireless device of claim 18 wherein the wireless device is implemented as a base device capable of communicating with a plurality of transmit devices including the transmit device.

20. The wireless device of claim 15 wherein the base device is implemented as a gaming console.
